(19) United States
(12) Patent Application Publication
(10) Pub. No.: US 2016/0028756 A1
(43) Pub. Date: Jan. 28, 2016

(54) OPTICAL TRANSCEIVER

(71) Applicant: OPTO ELECTRONICS SOLUTIONS CO., LTD., Gwangju (KR)

(72) Inventor: Joon Sang YU, Gyeonggi-do (KR)

(21) Appl. No.: 14/446,959

(22) Filed: Jul. 30, 2014

(30) Foreign Application Priority Data
Jul. 28, 2014 (KR) 10-2014-0095753

(51) Int. Cl. H04L 29/06

(52) U.S. Cl. CPC H04L 63/1416

(57) ABSTRACT

Disclosed is an optical transceiver. The optical transceiver includes: a receiving unit receiving optical signal data from the outside; a photoelectric conversion unit performing interconversion of the optical signal data and electric signal data; a data classifying unit classifying the received data according to a predetermined condition; a control unit determining replication of data or not and a transfer direction of the data according to a classification result by the data classifying unit; and a transmitting unit transmitting the data replicated by the control unit to an external system.

### TECHNICAL FIELD

The present invention relates to an optical transceiver used in optical communications.0

### BACKGROUND ART

In general, an optical transceiver is a device that accommodates various optical communication functions in one package to modularize various optical communication functions to be connected with optical fibers. In recent years, as the optical transceiver, a bidirectional optical transceiver in which an optical transmitter using, as a light source, a laser diode which has low power consumption and is usable in a long distance and an optical receiver that performs optical communications by using a photodiode are modularized into one is primarily used.

In recent years, technological development to implement various operation administration maintenance (OAM) functions of which the optical transceiver takes charge in an optical communication system in a module level in addition to a basic function of the existing optical transceiver has been actively progressed.

Meanwhile, with an increase in request for mass storage of traffic data and a rapid communication speed, there is a tendency that distribution of the optical transceiver gradually increases and an optical communication network as a medium capable of transmitting mass data rapidly is recognized as an ultimate alternative of a wired communication network.

As described above, with an increase in weight of the optical communication network using an optical cable, a security problem of the optical communication network is emerging as a key problem. However, in a current network, a security analysis system is separately provided to request data which may influence a system to the separate security analysis system and analyze the requested data, and as a result, it is not high in efficiency of cost or processing speed for operating the system.

### SUMMARY OF THE INVENTION

The present invention has been made in an effort to provide an optical transceiver that requests precise analysis to an external system by extracting suspicious traffic to comprehensively monitor a network.

The present invention has also been made in an effort to provide an optical transceiver that classifies suspicious traffic to prevent the classified traffic from intruding into a host system and requests precise analysis to an external system to control traffic according to a result thereof.

An exemplary embodiment of the present invention provides an optical transceiver including: a receiving unit receiving optical signal data from the outside; a photoelectric conversion unit performing interconversion of the optical signal data and electric signal data; a data classifying unit classifying the received data according to a predetermined condition; a control unit determining replication of data or not and a transfer direction of the data according to a classification result by the data classifying unit; and a transmitting unit transmitting the data replicated by the control unit to an external system.

The data classifying unit may determine a risk grade by comparing some or all of data according to a predetermined condition.

The control unit may determine the replication of data or not and the transfer direction of the data according to the risk grade.

The optical transceiver may further include a data processing unit receiving the data replicated by the control unit and processing data in order to transmit the data to the external system.

The data processing unit may process data including at least one of a port number, a time stamp, classification information, and a sequence number.

The control unit may determine a port for outputting the data according to the data transfer direction.

According to exemplary embodiments of the present invention, a network can be comprehensively monitored by extracting suspicious traffic by using an optical transceiver without an additional device, and the suspicious traffic is classified to prevent the classified traffic from intruding into a host system and precise analysis is requested to an external system to control traffic according to a result thereof.

### BRIEF DESCRIPTION OF THE DRAWINGS

FIG. 1 is a conceptual diagram of an optical transceiver according to an exemplary embodiment of the present invention.

FIG. 2 is a configuration block diagram of the optical transceiver according to the exemplary embodiment of the present invention.

FIG. 3 is a conceptual diagram for describing an operation of an optical transceiver according to an exemplary embodiment of the present invention.

FIG. 4 is a conceptual diagram for describing an operation of an optical transceiver according to another exemplary embodiment of the present invention.

### DETAILED DESCRIPTION

The present invention may have various modifications and various exemplary embodiments and specific exemplary embodiments will be illustrated in the drawings and described. However, this does not limit the present invention to specific exemplary embodiments, and it should be understood that the present invention covers all the modifications, equivalents and replacements within the idea and technical scope of the present invention.

Terms including an ordinal number such as first or second may be used to describe various components but the components are not limited by the above terms. The above terms are used only to discriminate one component from the other component. For example, without departing from the scope of the present invention, a second component may be referred to as a first component, and similarly, the first component may be referred to as the second component. A terminology such as and/or includes a combination of a plurality of associated items or any item of the plurality of associated items.

It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, it is understood that no element is present between the element and the other element.

Terms used in the present application are used only to describe specific exemplary embodiments, and are not intended to limit the present invention. A singular form may include a plural form if there is no clearly opposite meaning in the context. In the present application, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms is have the same meaning as those generally understood by a person with ordinary skill in the art. It should be understood that terms defined in a generally used dictionary have the same meanings as contextual meanings of associated techniques and if not apparently defined in this application, the terms should not be interpreted as ideological or excessively formal meaning.

Hereinafter, exemplary embodiments of the present invention will be described in detail with reference to the accompanying drawings, in which like reference numerals refer to like or similar elements regardless of reference numerals and a duplicated description thereof will be omitted.

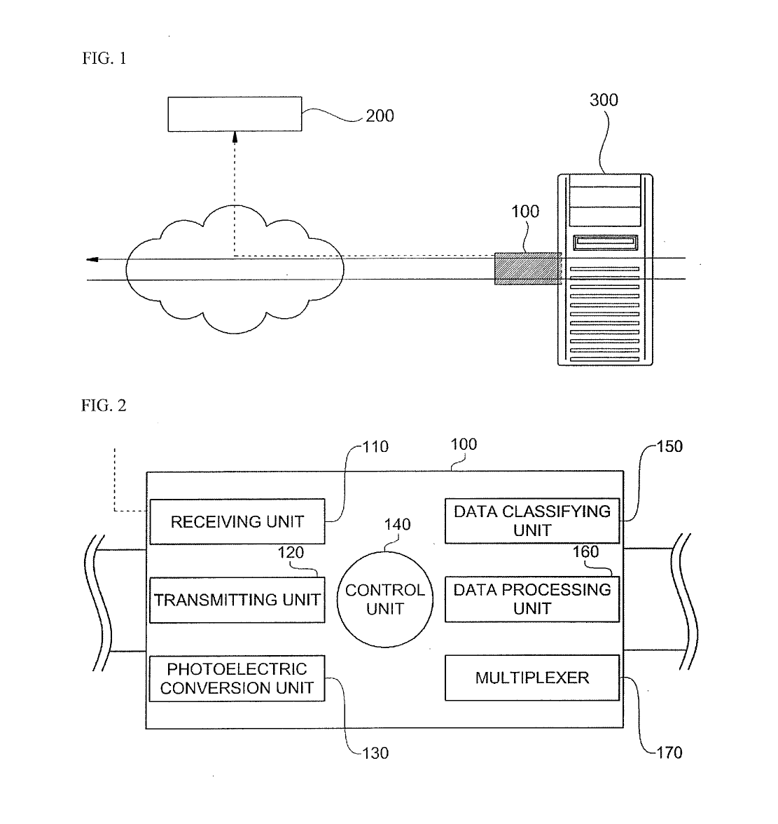

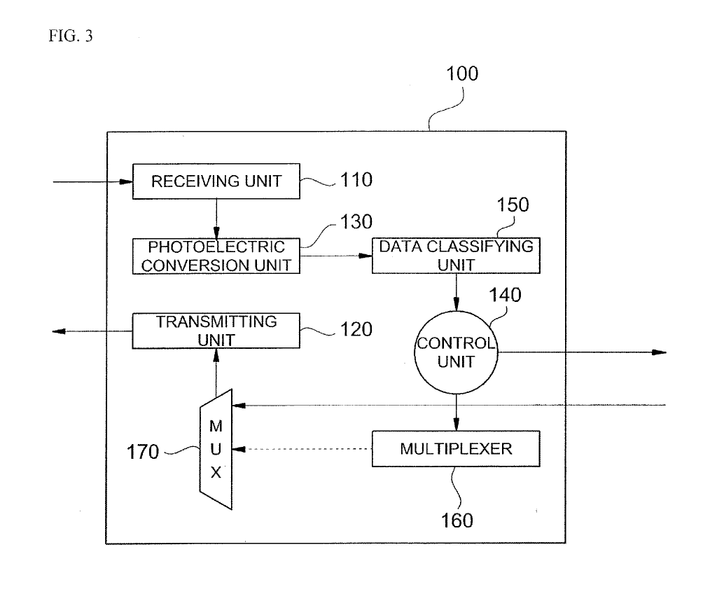

FIG. 1 is a conceptual diagram of an optical transceiver according to an exemplary embodiment of the present invention. FIG. 2 is a configuration block diagram of the optical transceiver according to the exemplary embodiment of the present invention.

Referring to FIGS. 1 and 2, the optical transceiver 100 according to the exemplary embodiment of the present invention may be configured to include a receiving unit 110, a transmitting unit 120, a photoelectric conversion unit 130, a control unit 140, a data classifying unit 150, a data processing unit 160, and a multiplexer 170.

In the exemplary embodiment of the present invention, the optical transceiver 100 is connected to a host system 300 and may receive optical signal data from the outside and convert the received optical signal data into an electric signal to provide the electric signal to the host system 300. The optical transceiver 100 may convert the electric signal received from the host system 300 into an optical signal and output the optical signal to the outside through optical fibers.

As the optical transceiver 100, various types of optical transceiver modules including an SFP, an XFP, and the like may be used and all types of optical transceiver modules may be used, which may convert the optical signal into the electric signal and provide the electric signal to the host system 300 or convert the electric signal into the optical signal and provide the optical signal to the outside through the optical fibers.

The control unit 140, the data classifying unit 150, and the data processing unit 160 may be implemented in the optical transceiver 100 according to the exemplary embodiment of the present invention by using an FPGA.

First, the receiving unit 110 may receive the optical signal data from the outside. The receiving unit 110 may receive the optical signal data through the optical fibers. The receiving unit 110 may be constituted by, for example, a photodiode and may be implemented by a single module from the transmitting unit 120 constituted by a laser diode.

The photoelectric conversion unit 130 may convert the optical signal data into electric signal data or the electric signal data into the optical signal data. The photoelectric conversion unit 130 may convert the optical signal data received from the outside into the electric signal data and provide the electric signal data into the host system 300 or the electric signal data received from the host system 300 into the optical signal data and output the optical signal data to the outside through the optical fibers.

The data classifying unit 150 may classify the received data according to a predetermined condition. The data classifying unit 150 may classify the data received through the optical fibers according to the predetermined condition or the data received from the host system 300 according to the predetermined condition. For example, initial predetermined bytes in the received data, for example, first 64 bytes are compared with prestored pattern data. The data classifying unit 150 matches the received data with the stored pattern data to classify the data. The data classifying unit 150 may, for example, match specific stored virus pattern data with the received data to classify matched data and unmatched data.

Alternatively, the data classifying unit 150 may classify the received data by using information received from the external system. The receiving unit 110 may receive information on a condition for classifying the data received from the external system 200 and classify the data by using the received information. The receiving unit 110 and the external system 200 may receive information for classifying the data by periodically performing data communications and the control unit 140 may update the received information. The transmitting unit 120 may request the information on the condition for classifying the data to the external system 200 according to a control by the control unit 140.

Alternatively, the data classifying unit 150 may classify a risk grade of the received data by comparing a predetermined condition and data. The data classifying unit 150 may, for example, classify received data matched with pattern data for a virus which may exert a critical influence on the system into data having a high risk grade and received data matched with pattern data for a virus which exerts little influence on the system into data having a low risk grade.

The data classifying unit 150 may also classify the data by dividing a matching degree in the matched data. That is, the data classifying unit 150 may classify the data according to a matching rate in the matched data. The data classifying unit 150 may classify data having a high matching rate into the data having the high risk grade and sequentially classify data having a low matching rate into the data having the low risk grade.

The control unit 140 may determine replication of data or not and a transfer direction of data according to a classification result of the data classifying unit 150. The control unit 150 may, for example, replicate data matched with specific virus pattern data and transmit the replicated data to the external system 200 through the transmitting unit 120. The control unit 140 may control the transfer direction so as to prevent the data matched with the specific virus pattern data from being transferred to the host system 300.

Alternatively, the control unit 140 replicates the data matched with the specific virus pattern data to transmit the replicated data to the external system 200 and transfer the replicated data to the host system 300. That is, the control unit 140 may control the data to be replicated according to the classification result by the data classifying unit 150, the replicated data to be transmitted to the external system 200, and original data not to be transferred to the host system 300 or control the data to be replicated and the replicated data to be transferred to the external system 200, and the original data to be transferred to the host system 300. The control unit 140 may determine a port for outputting the replicated data and the original data according to the transfer direction of the data.

The control unit 140 may determine whether to transfer the original data to the host system 300 according to a set-up. For example, the control unit 140 may determine the replication of the data or not and the transfer direction of the data according to the risk grade. The control unit 140 may control the data having the high risk grade to be replicated and the replicated data to be transmitted to the external system 200, and the original data not to be transferred to the host system 300 or control the data having the low risk grade to be replicated and the replicated data to be transmitted to the external system 200, and the original data to be transferred to the host system 300.

That is, the control unit 140 may control whether to transfer the original data by considering an influence which the data exerts on the host system 300 according to the risk grade. The control unit 140 may request precise analysis of the data having the high risk grade through the external system 200 and interrupt the original data not to be transferred to the host system 300 before receiving a precise analysis result and request precise analysis of the data having the low risk grade through the external system 200 and control the data having the low risk grade to be transferred to the host system 300 even before receiving the precise analysis result. The reason is that although the data having the low risk grade is actually analyzed as malicious data according to the precise analysis result, when the data is treatable through tracking, it is advantageous that the data is transferred to the host system 300 to be subjected to rapid data processing.

The data processing unit 160 may receive the replicated data from the control unit 140 and process data in order to transmit the received replicated data to the external system 200. The data processing unit 160 may configure a data packet including header information and trailer information including information on the external system 200 which is a destination, in the replicated data.

The data processing unit 160 may process data including at least one of a port number, a time stamp, classification information, and a sequence number included in the header information. The port number may include port information receiving the replicated data, the time stamp may include information on the time when the replicated data is replicated, the classification information may include information on the classification condition used when classifying the replicated data, and the sequence number may include information on a packet sequence of the replicated data.

The transmitting unit 120 may transmit the replicated data to the external system 200. The transmitting unit 120 may transmit the optical signal of the replicated data converted by the photoelectric conversion unit 130 to the external system 200 through the optical fibers. The transmitting unit 120 may be constituted by, for example, the laser diode and may be implemented by a single module from the receiving unit 110 constituted by the photodiode.

The multiplexer 170 receives the replicated data and the original data to output data for transmitting the received replicated data and original data through the transmitting unit to the outside.

The external system may precisely analyze the replicated data received from the optical transceiver.

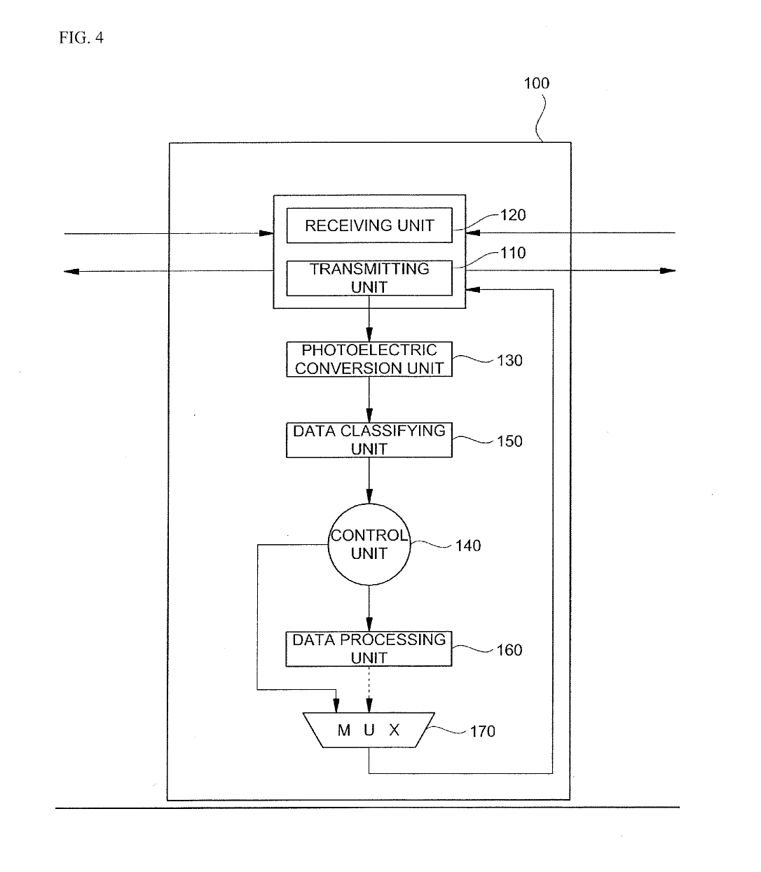

FIG. 3 is a conceptual diagram for describing an operation of an optical transceiver according to an exemplary embodiment of the present invention.

Referring to FIG. 3, the receiving unit 110 receives the optical signal data from the outside. The received data is converted into an electric signal through the photoelectric conversion unit 130 and transferred to the data classifying unit 150. The data classifying unit 150 classifies some or all of the received data according to a predetermined condition and the control unit 140 determines replication of data or not and a transfer direction of the data according to a classification result by the data classifying unit 150. The control unit 140 transfers the replicated data to the data processing unit 160 and the replicated data including header information and trailer information by the data processing unit 160 is multiplexed by the multiplexer 170 and transmitted to the external system through the transmitting unit 120. In this case, the control unit 140 determines a transfer direction of original data by determining whether to transfer the original data to the host system.

FIG. 4 is a conceptual diagram for describing an operation of an optical transceiver according to another exemplary embodiment of the present invention.

Referring to FIG. 4, the receiving unit 110 receives the optical signal data from both directions. The received data is converted into the electric signal through the photoelectric conversion unit 130 and transferred to the data classifying unit 150. The data classifying unit 150 classifies the received data according to a predetermined condition and the control unit 140 determines replication of data or not and a transfer direction of the data according to a classification result by the data classifying unit 150. The control unit 140 transfers the replicated data to the data processing unit 160 and the replicated data including header information and trailer information by the data processing unit 160 is multiplexed by the multiplexer 170 and transmitted to the external system through the transmitting unit 120. In this case, the control unit 140 determines a transfer direction of original data by determining whether to transfer the original data to the host system.

A term of ‘unit’ used in the exemplary embodiment means software or a hardware component such as a field-programmable gate array (FPGA) or ASIC, and ‘unit’ performs predetermined roles. However, ‘unit’ is not a meaning limited to software or hardware. ‘Unit’ may be configured to be positioned in an addressable storage medium and configured to regenerate one or more processors. Therefore, as one example, ‘unit’ includes components such as software components, object oriented software components, class components, and task components, processes, functions, attributes, procedures, subroutines, segments of a program code, drivers, firmware, a microcode, a circuit, data, a database, data structures, tables, arrays, and variables. Functions provided in the components and ‘units’ may be joined as a smaller number of components or further separated into additional components and ‘units’. In addition, the components and ‘units’ may be implemented to regenerate one or more CPUs within a device or a security multimedia card.

The present invention has been described in detail with reference to preferred embodiments thereof. However, it will be appreciated by those skilled in the art that various modifications and changes can be made within the scope without departing from the spirit and the area which are defined in the appended claims and their equivalents.

1. An optical transceiver comprising:
a receiving unit receiving optical signal data from the outside;
a photoelectric conversion unit performing interconversion of the optical signal data and electric signal data;
a data classifying unit classifying the received data according to a predetermined condition;
a control unit determining replication of data or not and a transfer direction of the data according to a classification result by the data classifying unit; and
a transmitting unit transmitting the data replicated by the control unit to an external system;
wherein the control unit controls the data having a high risk grade and replicates the high risk grade data, and the replicated data having the high risk grade is transmitted to the external system, and the original data having the high risk grade is not transferred to the host system and whether to transfer the original data having the high risk grade to the host system is determined based on an analysis results of the external system, and controls the data having a low risk grade and replicates the low risk grade data, and the replicated data having the low risk grade is transmitted to the external system, and the original data having the low risk grade is transferred to the host system and whether to track the original data having the low risk grade transferred to the host system is determined based on the analysis results of the external system.

2.-3. (canceled)

4. The optical transceiver of claim 1, further comprising:
a data processing unit receiving the data replicated by the control unit and processing data in order to transmit the data to the external system.

5. The optical transceiver of claim 4, wherein the data processing unit processes data including at least one of a port number, a time stamp, classification information, and a sequence number.

6. The optical transceiver of claim 1, wherein the data classifying unit matches an initial predetermined part of the received data with stored pattern data and classifies data according to matching or not.

7. The optical transceiver of claim 6, wherein the data classifying unit matches first 64 bytes of the received data with the stored pattern data and classifies data according to matching or not.

8. The optical transceiver of claim 1, wherein the control unit determines a port for outputting the data according to the data transfer direction.

9. The optical transceiver of claim 1, wherein the data classifying unit classifies data received by using information received from the external system.

10. The optical transceiver of claim 1, wherein the data classifying unit classifies data received from a host system and an Ethernet network according to a predetermined condition.
